(19) United States
(12) Patent Application Publication
(10) Pub. No.: US 2014/0008592 A1
(43) Pub. Date: Jan. 9, 2014

(54) WIRE MANIPULATOR

(71) Applicant: Guk Jin YANG, Yongin (KR)

(72) Inventor: Guk Jin YANG, Yongin (KR)

(21) Appl. No.: 13/936,038

(22) Filed: Jul. 5, 2013

(30) Foreign Application Priority Data
Jul. 6, 2012 (KR) 10-2012-0074056

(51) Int. Cl. B66D 1/74

(52) U.S. Cl. CPC B66D 1/7405
USPC 254/278

(57) ABSTRACT

A wire manipulator capable of accurately transferring an object to a desired position on a plane using a strand of wire is provided. The wire manipulator includes a frame having an inner space formed therein, three or more wire modules spaced apart from and coupled to the frame, a moving object coupled to the wire modules, and a control unit configured to control the wire modules. Here the wire module may include a wire coupled to the moving object, and a motor device configured to be able to wind or unwind the wire.

### CROSS-REFERENCE TO RELATED APPLICATION

This application claims priority to and the benefit of Korean Patent Application No. 2012-0074056, filed Jul. 6, 2012, the disclosure of which is incorporated herein by reference in its entirety.

### BACKGROUND

The present invention relates to a wire manipulator, and, more particularly, to a wire manipulator capable of positioning an object on a plane.

A robot has been widely used as a means for positioning an object. The robot is composed of a motor, gears and arms, and thus may be used to transfer the object. Such a robot has a complicated arm structure, and thus has a problem in that it is difficult to control positioning of an object.

Therefore, there is a demand for an apparatus having a simpler configuration, which is able to transfer an object on a plane.

### SUMMARY OF THE INVENTION

The present invention is designed to solve the problems of the prior art, and therefore it is an object of the present invention to provide a wire manipulator capable of accurately transferring a moving object to a desired position on a plane using a strand of wire.

It is another object of the present invention to provide a wire manipulator capable of preventing damage of an object coupled to a moving object by coupling a strand of wire through one coupling site of the moving object because positioning of the moving object may be stably controlled and the strand of wire does not bounce to the moving object even when damage of the wire takes place.

One aspect of the present invention provides a wire manipulator including a frame 11 having an inner space formed therein, three or more wire modules 12 spaced apart from and coupled to the frame 11, a moving object 13 coupled to the wire modules 12, and a control unit 14 configured to control the wire modules 12. Here, the wire module 12 includes a wire 121 coupled to the moving object 13, and a motor device 122 configured to be able to wind or unwind the wire 121 wherein the wire 121 is coupled to the motor device 122 through the moving object 13.

In this case, the wire 121 may be arranged through the moving object 13 so that one end of the wire 121 can be fixed at a position adjacent to the motor device 122 and the other end of the wire 121 can be coupled to a pulley coupled to the motor device 122.

Also, the wire 121 may be in a loop shape, and coupled to the pulley of the motor device 122 through the moving object 13.

In addition, a roller may be formed at the coupling site between the moving object 13 and the wire 121.

### BRIEF DESCRIPTION OF THE DRAWINGS

The above and other objects, features and advantages of the present invention will become more apparent to those of ordinary skill in the art by describing in detail one or more embodiments thereof with reference to the attached drawing, in which:

FIGS. 1 and 2 are plane views showing a wire manipulator according to one embodiment of the present invention.

### DETAILED DESCRIPTION

One or more embodiments of the present invention are described below in sufficient detail to enable those of ordinary skill in the art to embody and practice the present invention. It is important to understand that the present invention may be embodied in many alternate forms and should not be construed as limited to the embodiments set forth herein.

It will be understood that, although the terms first, second, A, B, etc. may be used herein in reference to elements of the invention, such elements should not be construed as limited by these terms. For example, a first element could be termed a second element, and a second element could be termed a first element, without departing from the scope of the present invention. Herein, the term “and/or” includes any and all combinations of one or more referents.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements. Other words used to describe relationships between elements should be interpreted in a like fashion (i.e., “between” versus “directly between,” “adjacent” versus “directly adjacent,” etc.).

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

With reference to the appended drawings, one or more embodiments of the present invention will be described in detail below. To aid in understanding the present invention, like numbers refer to like elements throughout the description of the figures, and the description of the same elements will not be reiterated.

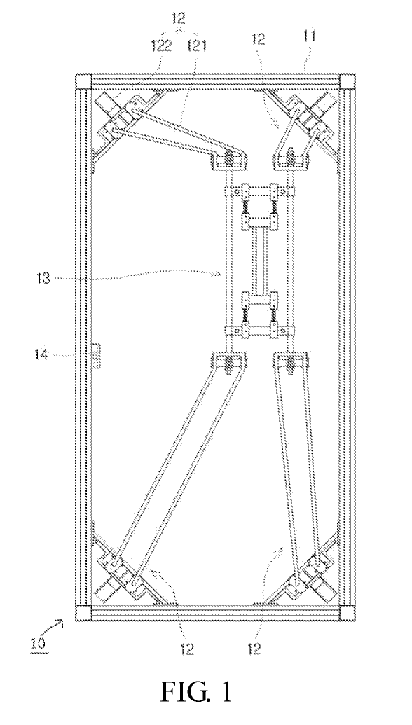

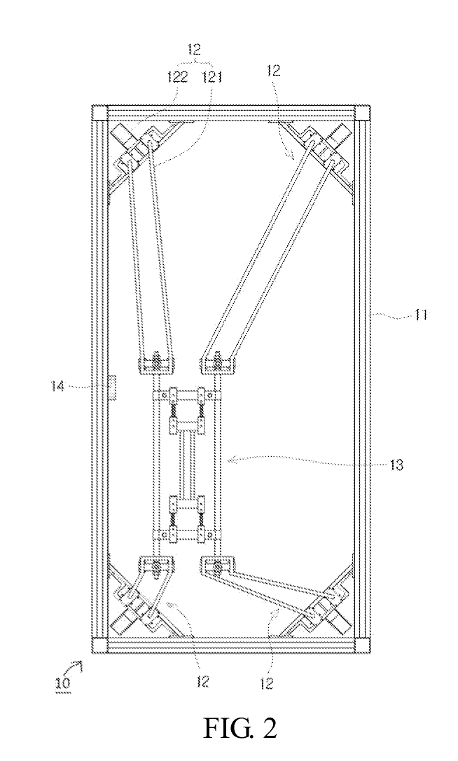

FIGS. 1 and 2 are plane views showing a wire manipulator according to one embodiment of the present invention.

A wire manipulator 10 includes a frame 11 having an inner space formed therein, three or more wire modules 12 spaced apart from and coupled to the frame 11, a moving object 13 coupled to the wire modules 12, and a control unit 14 configured to control the wire modules 12. Here, the wire module 12 includes a wire 121 coupled to the moving object 13, and a motor device 122 configured to be able to wind or unwind the wire 121.

The wire 121 is arranged through the moving object 13, so that one end of the wire 121 can be fixed at a position adjacent to the motor device 122 and the other end of the wire 121 can be coupled to a pulley coupled to the motor device 122.

The frame 11 is formed in a shape having an inner space. According to one embodiment of the present invention, the frame 11 may be formed in various shapes such as rectangular, triangular, or circular shapes. The frame 11 may be made of a material such as metal or plastic.

Three or more of the wire modules 12 may be coupled to the frame 11. When at least three of the wire modules 12 are arranged spaced apart from the frame, the wire modules 12 may form a plane, and transfer the moving object 13 on the plane by adjusting the length of the wire 121. When the number of the wire modules 12 is 3, the wire modules 12 can transfer the moving object 13 on an inner part of a triangular plane formed by connecting three connection points at which the wire modules 12 are positioned.

According to one embodiment of the present invention, the number of the wire modules 12 is 4, and thus the connection points are located at four corners of the rectangular frame 11, respectively.

Each of the wire modules 12 is composed of a wire 121 and a motor device 122. The wire 121 is composed of one strand of wire, and one end of the wire 121 is coupled to the frame 11 through a hole formed in the moving object 13. The other end of the wire 121 is coupled to the motor device 122. In this case, the motor device 122 can be driven to wind or unwind the wire 121. As the wire 121 is wound around or unwound from the motor device 122 as described above, a distance from the moving object 13 may be adjusted.

The motor device 122 may be composed of a motor, a reduction gear, a pulley, etc. The wire 121 may be wound or unwound by forward or reverse revolutions of the motor device 122.

As the wire module 12 shown in FIG. 1 systemically runs to wind or unwind the wire 121, the moving object 13 may be transferred to a predetermined position (i.e., a position shown in FIG. 1 or FIG. 2) on an inner plane of the frame 11.

When the moving object 13 is to be transferred to a predetermined position, the control unit 14 adjusts a length of the wire 12 by controlling the four wire modules 12 to correspond to the predetermined position of the frame 11, respectively. As a result, the moving object 13 may be transferred to a desired position, as shown in FIG. 1 or FIG. 2.

According to one embodiment of the present invention, when a strand of wire 12 passes through the moving object 13 and is coupled to one lateral surface of the moving object 13, the wire 12 may endure external impacts without easily causing damage thereto. In addition, the wire 12 may serve to absorb the impacts. Meanwhile, even when the wire 12 is damaged, the damaged wire 12 will bounce toward the frame 11 since both ends of the wire 12 are coupled to the frame 11. As a result, the wire 12 does not collide with an expensive object being coupled to the moving object 13, thereby preventing damage of the expensive object.

A roller may be provided in a coupling site between the wire 121 and the moving object 13 to reduce friction between the wire 121 and the moving object 13. Friction at the coupling site between the wire 121 and the moving object 13 may be generated by rotation of the motor device 122. The roller serves to minimize such friction.

Also, the wire 121 may be formed in a loop shape. In this case, one end of the wire 121 is coupled through the moving object 13, and the other end of the wire 121 is wound around the pulley of the motor device 122. By coupling the wire 121 to the pulley of the motor device 122, the length of the wire 121 may be increased or reduced by rotation of the pulley.

The wire manipulator 10 according to one embodiment of the present invention may be arranged in pairs. A pair of wire manipulators 10 may be arranged in parallel to help a patient to do his/her remedial exercise. In this case, the patient's each foot may be put on a pair of the moving objects 13, respectively. The patient may slowly walk as the moving objects 13 operate.

In addition to such medical use, the wire manipulator 10 may be used in various fields of applications where the moving objects 13 need to move in a two-dimensional manner.

The present invention provides a wire manipulator capable of accurately transferring a moving object to a desired position on a plane using a strand of wire.

Also, the present invention provides a wire manipulator capable of preventing damage of an object coupled to a moving object by coupling a strand of wire to one coupling site of the moving object because positioning of the moving object may be stably controlled and the strand of wire does not bounce to the moving object even when damage of the wire takes place.

While the invention has been shown and described with reference to one or more embodiments thereof, it will be understood by those skilled in the art that various changes in form and details may be made therein without departing from the scope of the invention as defined by the appended claims.

What is claimed is:

1. A wire manipulator comprising:
a frame having an inner space formed therein;
three or more wire modules spaced apart from and coupled to the frame;
a moving object coupled to the wire modules; and
a control unit configured to control the wire modules,
wherein the wire module comprises:
a wire coupled to the moving object; and
a motor device configured to be able to wind or unwind the wire, the wire being coupled to the motor device through the moving object.

2. The wire manipulator of claim 1, wherein the wire is arranged through the moving object so that one end of the wire is fixed at a position adjacent to the motor device and the other end of the wire is coupled to a pulley coupled to the motor device.

3. The wire manipulator of claim 1, wherein the wire is coupled in a loop shape to the pulley of the motor device through the moving object.

4. The wire manipulator of claim 1, further comprising a roller which is formed at a coupling site between the moving object and the wire.
